(19) United States
(12) Patent Application Publication
(10) Pub. No.: US 2006/0083469 A1
(43) Pub. Date: Apr. 20, 2006

(54) Means and method for coupling optical components

(76) Inventors: Karim Faid, Nepean (CA); Sandy Owega, Ottawa (CA)

Correspondence Address: National Research Council of Canada;Intellectual Property Services, Bldg. M58, Room EG-12, 1200 Montreal Road, Ottawa, ON, K1A 0R6, CA

(21) Appl. No.: 11/249,456

(22) Filed: Oct. 14, 2005

Related U.S. Application Data
(60) Provisional application No. 60/618,584, filed on Oct. 15, 2004.

(51) Int. Cl. G02B 6/00

(52) U.S. Cl. 385/122

(57) ABSTRACT

There is disclosed herein a process of optically and mechanically coupling two or more than two optical components with a strippable and removable refractive index matching silicone elastomer mixture and the mixture itself.

### FIELD OF THE INVENTION

This invention relates to a means and method for optical and mechanical coupling optical components. More specifically it relates to such means and methods wherein, the coupling means can either form a durable and/or a temporary bond.

### BACKGROUND

The recent convergence of a number of scientific disciplines, such as chemistry, physics and biology has resulted in the integration of various technologies and the development of a number of novel applications using optoelectronic devices where polymer microfluidics and biophotonics are closely integrated. Such integrations require, among other things, designing optics for the refractive index matching of many different materials and the knowledge of the refractive index of the adjoining optical materials. Different materials and methods have been developed over the years to achieve the refractive index matching.
Optical fluids. These materials are the most common and quite convenient to apply, particularly for temporary use in testing or prototyping. However, as true fluids, they will tend to flow out of the optical interface unless properly contained with seals.
Optical gels. Gels are of higher viscosity than optical fluids and may not require containment seals to be held in the optical interface. However, they are quite messy to apply and are not easy to remove or clean.
Optical thermosets These are soft plastics which, when cured, provide index matching as well as some dimensional rigidity. They still have elastic properties and so can provide some strain relief within the interface although not as much strain relief as provided by a gel. Most of these materials, which are basically optical glues, are however also extremely difficult to remove once applied to a surface and coupled components are usually not detachable. Another application relies on the use of soft elastic materials that are deposited in precise geometries onto the surfaces of the components to be optically coupled and by applying sufficient pressure, to obtain a reversible coupling. The application of external pressures can however be quite damaging to the optical components, and no actual product is believed to be available using this methodology.

The following patents, patent applications and papers also relate to optical couplings and may be of background interest. The inclusion of a reference to a document herein is neither an admission nor a suggestion that it is relevant to the patentability of anything disclosed herein.
1. Biacore: Optical coupling device and method for its production: WO 97/19375 and WO9005317
Soft and elastic materials have been deposited in precise geometries and thick enough layers onto the surfaces of the components to be optically coupled. Through the application of sufficient pressure, a satisfying coupling is alleged to be formed. The most apparent drawback of this approach is the requirement of depositing very specific soft materials shapes (dome or stepped) on the surfaces of the optical components, increasing significantly the cost of these components and also introducing the necessity of applying sufficient pressures to ensure a correct optical contact.
2. Corning, Waveguides and Method for Making them; U.S. Pat. Nos. 6,744,951 and 5,991,493 (Optically transmissive bonding material)
Use of photo-polymerizable materials to create an optical coupling between 2 waveguides. This material is not believed to be practically removable. In the second one, a sol-gel material is used which cannot be practically removed from the substrate.
3. Toray Silicone, Refractive-index coupling elastic compositions for optical communications fiber joints, EP0195355
Silicone compositions for use in refractive index matching applications
4. Hewlett-Packard, Optical index matching system, EP0712011 Similar to Biacore patents
5. Masadome et al, Anal. Biaonal. Chem. (2002) 373) 222-226

Preparation of refractive index matching polymer film alternative to oil for use in a portable surface-plasmon resonance phenomenon-based chemical sensor method.

The authors describe using a thin PVC film made flexible by the incorporation of huge amount of plasticizers (ratio of 1 to 5 by weight) which is far higher than the conventional ratio of 1 to 0.5 or 1 to 0.15 by weight used in flexible PVC. The components are dissolved in a solvent and evaporation of the solvent gives a thin film that is sandwiched between two optical components, and pressure applied. Using a silicone film obtained by evaporation and which contains no low molecular weight products, they do not report observing any coupling. The optical coupling with the PVC film has been probably obtained through the plasticizers, that probably acts more as an optical oil encapsulated in a polymer matrix. It is well known that heavily loaded PVC can leach out considerable amount of plasticizers, which make them in fact undesirable materials in many applications.
6. Samantha R. Connor, SPIE, Vol. 3937, “Micro and Nano Photonic Materials and devices”, Paper No: 3937-25
Engineering Properties of high refractive index optical gels for photonic device applications, Nye Optical Products, Fairhaven Mass., USA
Description of the characteristics and properties of optical silicone elastomers and gels.

### SUMMARY OF THE INVENTION

The present invention provides a material useful for mechanically and optically bonding two or more than two optical components which is easy to apply, and which can be practically removed leaving little if any residue thereby allowing for reversible mechanical coupling and optical coupling of the optical components.

The invention offers a process of coupling optical components where a removable and strippable silicone elastomer is spread on a first optical component, this coupling layer is laid to rest until all of the air bubbles are removed until the layer is substantially free of trapped air, the second optical component is bonded to the coupling layer to form a structure and the entire structure is cured until the structure is set.

The invention also presents a mixture for coupling optical components which comprises about ten part of silicone elastomer for one part of a curing agent.

### BRIEF DESCRIPTION OF THE DRAWINGS

FIG. 1 illustrates an embodiment of the optical and mechanical coupling process

FIG. 2 illustrates an embodiment of an SPR sensor

FIG. 3 illustrates an SPR profile using various sensors

FIG. 4 illustrates an SPR profile with increasing thickness of optical gels

FIG. 5 illustrates an SPR resonance as a function of thickness

FIG. 6 illustrates a refractive index variation as a function of the percent weight

### DETAILED DESCRIPTION OF THE INVENTION

This invention makes use of a family of polymer materials, silicone elastomers, which are known to exhibit superior mechanical, chemical and optical properties over a broad temperature region. These materials possess useful properties such as good low-temperature flexibility, excellent electrical properties, tunable optical characteristics, chemical inertness, water repellency and biocompatibility. These polymers are also known to possess a very low surface tension making them extremely attractive as non-sticking materials. One example of such polymers is Polydimethyl siloxane (PDMS). The preferred silicone elastomers would be an optically transparent elastic material and identifying such materials is, in light of the disclosure herein, within the capacity of one skilled in the art. Characteristics of interest may in some instance include: crosslinkability or polymerizability, refractive index, strength, and adhesion characteristics. Examples of broad material classes may include rubbers or elastomers, such as silicone or polybutadienes, epoxy resins, polyurethanes, etc.

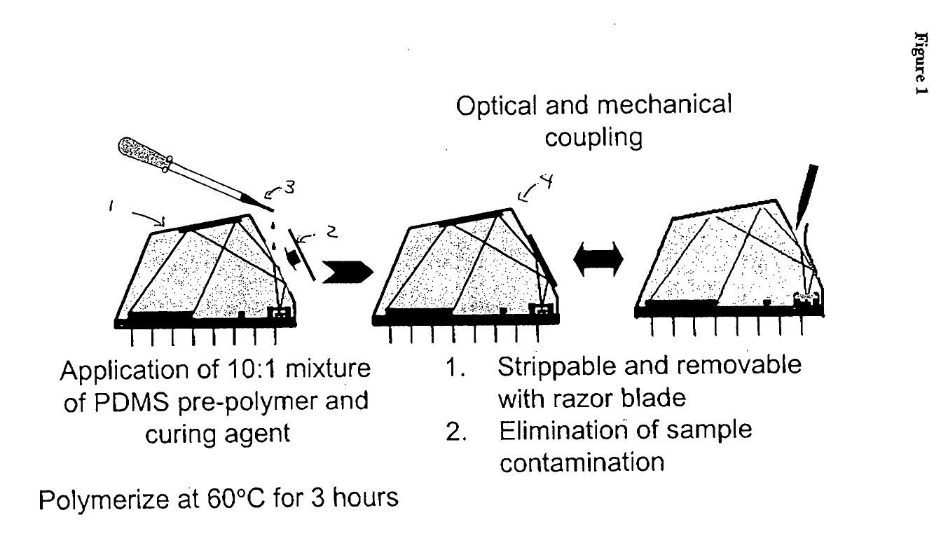

In one embodiment of the invention as illustrated in FIG. 1 the process for coupling two optical components (1 and 2) comprises at least partly covering the surface of the first component with a removable and strippable silicone elastomer (3). The removable strippable silicone elastomer (3) then forms a coupling layer; this layer is then left to rest so as to allow it to outgas. The bubbles present after applying the coupling layer can be small, not visible to the eye, but could still cause unwanted loss and scattering of light.

Once the bubbles have been removed the second optical component can be placed over the coupling layer to form a structure (4).

The structure (4) is then cured. Different curing methods can be used.

The structure can be cured at a temperature which ranges from room temperature to the maximal temperature tolerated by the optical components. The curing time will depend on the thickness of the coupling layer as well as on the curing temperature. For example some structures require curing at 60 degrees Celsius for about three hours, while other can be cured at 90 degrees for two hours. The curing temperature is determined by operational needs and on the tolerance of the optical component. A technician skilled in the art would be able to make that determination.

UV and moisture curing can also be used to set the structure instead of or in addition to heat curing.

It is possible to inject a removable and strippable silicone elastomer (3) in a liquid viscous form between the two optical components (1 and 2) to form a coupling layer between the optical components resulting in a structure (4).

It is possible to form a structure (4) having three or more optical components (not illustrated) the same way as described above. It is merely a question of following the same steps and attaching the third component to a surface of the desired optical component.

The refractive index of the coupling layer can be substantially matched to the refractive index of the optical components when the optical components have the same refractive index. This will result in less transmission loss for the structure.

In the case where the optical components have a different refractive index, there will always be a transmission loss. In this case the curing layer will be selected with a refractive index which minimizes this loss. This could be done by selecting the silicone elastomer to have a refractive index which matches the average of the two optical component's refractive indices, or by matching the refractive index of one of the optical components. Other combinations are also possible. A technician skilled in the art would be able to determine the refractive index for the coupling layer that would minimize the transmission loss for the structure.

The novel all solid state optical coupling has been demonstrated with surface plasmon resonance (SPR) experiments. The solid state optical coupling between optical components such as a stationary optical component and a disposable optical component can also include absorbance, reflectometry, refractometry, polarometry, interferometry and fluorescence experiments. Many of these characterization techniques involve prism coupling for refractive index measurements on a planar surface, light coupling to/from light-wave guiding units for communication and/or detection, light coupling to/from light conducting units for transmission, reflection, light scattering and absorbance measurements, imaging light coupling to/from microscope slide to microscope, coupling illuminating light to/from substrate glass and cover-glass in microscopic procedures, and coupling light within the infrared region for efficient heating of certain details, eg skin portions.

Several of the microscopic techniques can encapsulate the specimen, thus reducing contamination, and next directly couple the encapsulated specimen to the objective lens of the microscope to exclude air. Other encapsulating applications of these silicone elastomers include a highly efficient photodiode sensor that can provide refractive index matching for the optical components inside the package.

Fiber optic telecommunication splices can be optically coupled with the silicone elastomers to provide mating between fused silica fibers. Additionally, optical fiber-to-planar waveguide connections require materials like PDMS, since they are stable, a fundamental requirement when the fiber-to-planar waveguides are subjected to extreme temperatures and pressures. Furthermore, all state solid optical coupling provides the ability to position optical fibers to waveguides created on other desirable substrates such as silicon wafers, lithium niobate wafers and printed circuit boards.

Medical diagnostic and physiological applications of all solid state optical coupling includes the diagnostic and therapeutic monitoring of skin using a non-invasive optical/fluorescence technique. “Smart” polymer nanoparticles would be incorporated in a tattoo that is initially on the silicone elastomers with a refractive index of the skin interface. This tattoo is transferred onto the skin, whereby all solid state optical coupling would enhance sample volume localization. The silicone elastomer can then be reused by applying the tattoo with the “smart” polymer nanoparticles.

In one example, PDMS pre-polymer, which is a viscous slurry, has been sandwiched between two optical components (a prism and a gold-coated microscope slide) and cured. The curing time can vary from 2 hours (at 100° C.) to several hours (room temperature) After curing, the two components are both physically and optically coupled. The optical characteristics of this solid-state refractive index matching material were compared to those obtained using a standard refractive index matching oil or optical gel.

The comparison of the detection limit and sensitivity of the PDMS modified SPR sensor and an unmodified SPR sensor indicated substantially identical analytical capabilities. Calibration curves for sucrose concentrations were investigated with both SPR sensors to validate the biosensors proper operation. Calibration curves that are used to quantify liquid solutions do not appear to be compromised when PDMS couples the glass slide to the sensor in the solid state. Moreover, similar results were obtained using conventional refractive-index matching oils and gels.

Once cured, the two optical components can be physically separated very easily due to the very low adhesion characteristics of the PDMS film, provided that the substrate were adequately passivated to avoid the covalent attachment of the PDMS. This is usually done by removing or reacting silanol groups to obtain highly hydrophobic surfaces. The removal of the silanol groups is usually obtained by dipping the substrate in diluted hydrofluoric acid, while allowing the condensation of a variety of organosilane derivatives (such as alkyl-trimethoxy or alkyl-trichloro silanes) on the substrate provide for highly hydrophobic surfaces that do not bind to the PDMS. The coupling layer can be peeled very easily from almost any such surface, without leaving any significant trace. After the removal of the coupling layer, further surface modifications can be carried out on the gold-coated surface which can be re-coupled again to the sensor through the application of a new PDMS pre-polymer followed by its curing.

These silicone elastomers are preferably liquid (prior to curing) and solid (after curing). Such a dual character allows for an extreme versatility in their use. The initial application in liquid form allows the elimination and compensation of any surface defects between the two optical components.

The liquid state of these materials prior to curing also allows for the removal of air bubbles that could be trapped between the two optical components, through the application of an adequate degassing action prior to curing. The very low shrinking coefficient and thermal stability upon curing ensures an extremely stable physical and optical coupling. Moreover, their refractive index can be easily tuned over a large range making them potentially suitable in a number of photonic, biophotonic and microfluidic applications where they may offer definitive advantages.

### EXAMPLE 1

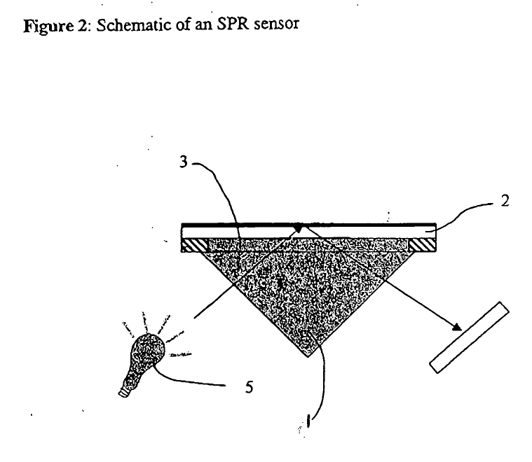

Surface plasmon resonance (SPR) is a versatile analytical technique used for several purposes, ranging from the detection of toxins to the kinetics of antibody-antigen reactions. It measures changes in the refractive index close to a sensing surface, which typically is a thin gold film. A number of desk-size commercial systems are now available that offer enough sensitivity and selectivity for the detection of various environmental, biological and chemical moieties. Portable and field deployable SPR systems may find an increasing use in a number of domains such as in life sciences, drug discovery, point of care diagnostics, environmental testing, bio defense or food safety. One of such portable instrument is the Texas Instruments SPREETA sensor, a compact and miniaturized device that uses the SPR technique, and has a good analytical performance. In this integrated device, plane-polarized light from an LED (5) is reflected from a gold surface (1) and the angle and intensity of the light is measured (FIG. 2). The intensity of the light is a minimum at only one angle. This angle is used to calculate the effective Refractive Index (RI) at the gold surface. When molecules bind to the gold surface, the measured RI changes. The gold surface, attached to one of the facet of the sensor, can be covered with a specific coating that can be customized for essentially any molecule for which detection is desired, providing the analytical specificity. The deposition of such specific coatings may, however, require the use of experimental conditions that are not compatible with the sensor's materials and electronics. Using an Aqua Regia solution, the gold surface can be stripped from the sensor and a gold-coated glass slide can be coated with the required coating, and used as the sensing surface, provided that an adequate refractive index matching material is used to optically couple the sensor and the gold-coated slide. This is typically achieved by using refractive index matching oil or gels to reduce reflection losses and obtain an adequate optical coupling. The conventional refractive index matching oil is usually placed between the gold-coated slide and the sensor surface. The low viscosity of these oils give rise to potential contamination of the sensing surfaces rendering, this simple procedure unsuitable for portable and field-deployable instruments, where simplicity and rapidity are the main requirements. The use of thixotropic gels has been advertised as an alternative, and although they may offer a higher mechanical firmness of the optical bondings, they cannot be removed easily without the risk of also contaminating the sensing surfaces. Therefore, there is a need to develop all solid-state alternative methods for optically coupling two optical components to address the drawbacks of these conventional refractive index matching materials.

Recently, an alternative to the use of refractive index matching oils have been reported, through the use of a plasticized poly(vinyl chloride) (PVC) film as a solid-state refractive index matching material. In that study, a thin polymer film was formed by dissolving and mixing, in an organic solvent, a PVC powder and two plasticizers, dioctyl phthalate (DOP) and tricresyl phosphate (TCP). The formed film was then positioned between a gold-coated substrate and an SPR sensor and a dip similar to that obtained when using matching refractive index oil is obtained. A similar attempt to use cured silicone rubber films failed to produce a similar SPR profile, apparently because of a mismatch in the refractive index of this film and those of the glass slide and the sensor chip. It has to be noticed however, that the proportion of plasticizers used in this experiment is extremely high (1.0 g of plasticizer for 0.2 g of PVC), a greater weight content than that usually found in flexible bags or tubing made of PVC. Even with such relatively small amount, numerous studies have shown that these plasticizers, which are not chemically bound to the PVC matrix, may leach extensively. It is therefore quite plausible that the refractive index matching is mainly obtained through the action of these leached small molecules, which therefore may suffer from the same drawbacks as the conventional matching oils and gels.

There is disclosed herein a novel and general process of coupling two or more than two optical components that make use of curable silicone elastomers, such as poly(dimethylsiloxane) (PDMS), and capable of optically and mechanically bonding two or more than two optical components either in a durable or a temporary way. These polymers are already being used in a number of domains and are known to exhibit superior mechanical, chemical and optical properties over a broad temperatures region. These materials possess unique properties such as good low-temperature flexibility, excellent electrical properties, tunable optical characteristics, chemical inertness, water repellency and biocompatibility. These polymers are also known to possess one of the lowest surface tension making them extremely attractive as non-sticking materials.

This example relates to results demonstrating the potential of using an all solid-state optical coupling material between a gold sensing slide and a commercially available SPR chip, the SPREETA sensor from Texas Instruments. The analytical capabilities of the sensor using PDMS, as an alternative coupling medium, are demonstrated through comparison with typical refractive index media and an unmodified regular SPREETA sensor. Finally, the response of the sensor was evaluated with methods previously reported. (Naimushin (2002))

Specifically, polydimethyl siloxane (PDMS) is optically transparent in the visible wavelength range, solid-state, chemically inert, and low cost. Furthermore, the PDMS optically coupled film is removable, which provides reusability of the gold sensing surface for subsequent SPR experiments, and the PDMS does not contaminate the sample. This material has been used as a lens and as a medium to pass a fluid through a microchannel, but is believed to never have been reported as an all solid-state optical coupling material.

Materials

The refractive index matching oil (refractive index of 1.505) and optical gels (with refractive indices of 1.46 and 1.52), were purchased from Cargille Laboratories (NJ, USA). PDMS pre-polymer and curing agent (Sylgard 184) was purchased from Dow Corning (MI, USA). Sucrose and anhydrous ethanol were purchased at EMD (NC, USA) and Commercial Alcohols Inc. (ON, Canada), respectively. Glass slides, purchased from Fisher Scientific (Ontario, Canada) were prepared at the National Research Council (NRC) by sputtering, first a 5 nm interlayer of titanium to enhance the gold adhesion and 50 nm of gold.

Fabrication of PDMS Films

A 10:1 mixture of PDMS prepolymer and curing agent is carefully mixed and degassed prior to pouring an adequate amount into a polystyrene Petri dish to create a thin layer of material in the dish. The PDMS is thermally polymerized at 60° C. for 3 hours. After curing, a 3×3 cm² section of this PDMS film was removed from the Petri dish. The transmittance of a flat PDMS film was measured using a PerkinElmer Lambda 900 spectrophotometer (MA, USA) from 400 nm to 850 nm. The transmittance was next modeled with VASE32 software (NE, USA) to extract the refractive indices and extinction coefficients of the PDMS at different wavelengths.

SPR Chip

The SPR chip used in this study, the SPREETA sensor, is a commercially available device manufactured by Texas Instruments. Briefly, a diverging 840-nm light, provided by a LED, was p-polarized and traveled through an epoxy medium, coated with an optically opaque material. The light struck the back of a 50-nm thick gold film that was optically coupled to the epoxy medium. The reflected light was bounced from a mirror and monitored with a photodiode array containing 128 pixels, each pixel corresponding to a different angle of incidence on the back of the gold film. A plot of the reflectance against the pixel number was termed an SPR profile. A dip in the SPR profile at one angle of incidence, called the SPR angle, was the result of the excitation of surface plasmons at the gold surface. The SPR angle changed when media with different refractive indices were deposited on the gold surface.

Modification of the SPR Chip

The Spreeta sensor, as supplied by the manufacturer, is an integrated chip comprising all the elements required to carry out SPR measurements. In order to be able to use the sensor with home-made gold-coated slides, the gold surface of the SPR chip was removed from the sensor surface. This was accomplished by dipping in a solution of Aqua Regia (3:1 HCl:HNO₃) to remove the gold. The stripped sensing surface was washed with distilled water and dried. A gold-coated slide was then coupled to the stripped sensor surface by spreading a small amount of either the refractive index matching oil or the optical gel. When using PDMS, two methods were used to proceed with the coupling of the gold-coated glass slide and the sensor surface. In the in-situ method, a thin layer of a 10:1 mixture of PDMS pre-polymer and cross-linking agent was spread on the sensor surface and a gold-coated slide was positioned on top. The thickness of the PDMS film was adjusted by the use of intercalate of known thickness. Thermal polymerization is carried out at 60° C. for 3 hours. After curing, any excess of PDMS on the gold-coated surface was removed by peeling. Extreme care was to be taken to ensure that no bubbles remained between the two optical components. This was usually accomplished by leaving the SPR chip at room temperature for several minutes before starting the curing process. After utilization, the gold-coated glass is removed from the sensor surface by a razor blade and the remaining coated PDMS is peeled from the surfaces. The coupling with PDMS is also carried out using a free standing film prepared as shown above. A thin film of cured PDMS (with thickness between 200 and 500 μm) is carefully positioned between a gold-coated slide and the SPR sensor. A gentle rolling pressure is applied on top of the glass slide to ensure that a conformal contact is achieved.

SPR Software Analysis

The SPREETA™ application software that was used for all the experiments are detailed by the manufacturer (http://www.ti.com./spreeta). Briefly, the fast analysis method called First Moment of Resonance was used to calculate the SPR angle. The direction of the First Moment of Resonance calculation was below a baseline level of 0.85. The generated data was next calibrated with water to provide refractive index units. At the SPR angle, 15 refractive indices were used to reduce the uncertainty on the generated refractive index value.

Testing the Response of SPR Sensor

Before each experiment, the gold surface was wiped clean with an ethanol soaked kimwipe and air-dried with dry nitrogen. The SPR profile for water was then monitored for several minutes. A solution of sucrose or ethanol in water was characterized by the SPR sensor for several minutes by monitoring its SPR profile. The difference between the SPR angle of the solution and the water was next calculated and converted to a refractive index change. The gold surface was cleaned again as described above for further use.

In SPR, the two basic requirements that are important for any optical coupling material used for SPR are: 1) optically transparency, and 2) matching of the refractive index with those of the media surrounding it. The transmission for all the materials used in this study was found to be greater than 95% at 840 nm, the wavelength at which the SPR sensor operates. The PDMS, the oils and optical gels are all optically transparent in the visible to the near-IR wavelength range.

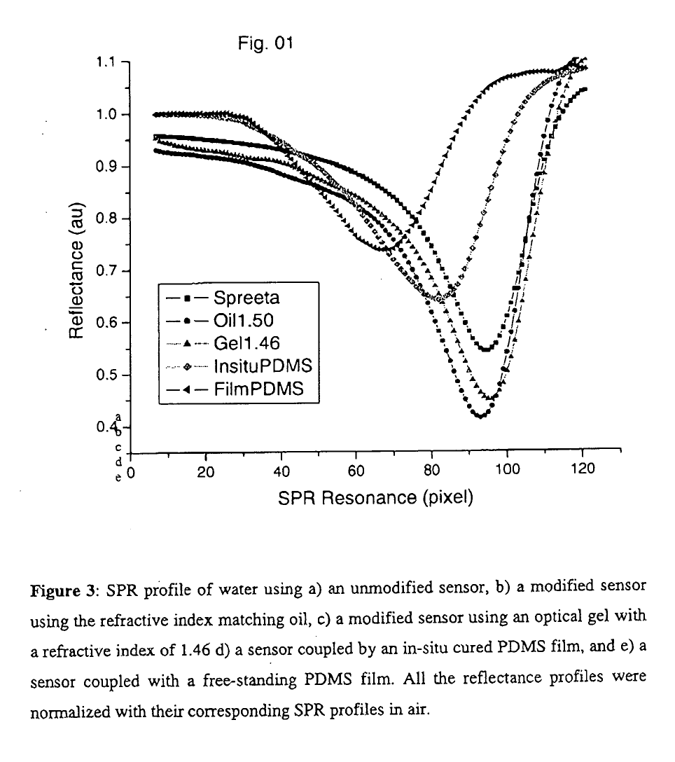

A comparison between an unmodified SPREETA SPR sensor and a modified one using the refractive index matching materials is performed to evaluate the SPR profiles in terms of the limitations that the refractive index matching materials impose. FIG. 3 shows the SPR profiles of water from: a) an unmodified sensor, b) a modified sensor using the refractive index matching oil, c) a modified sensor using an optical gel with a refractive index of 1.46 d) a sensor coupled by an in-situ cured PDMS film, and e) a sensor coupled with a free-standing PDMS film.

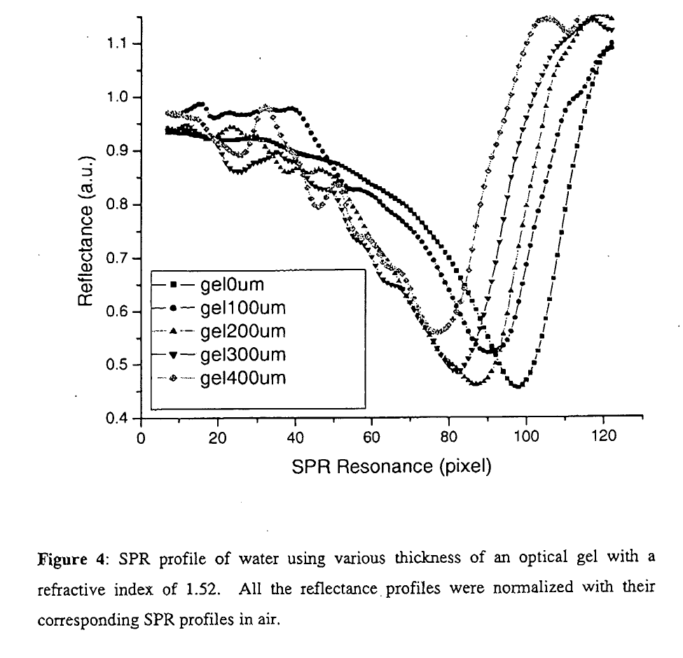

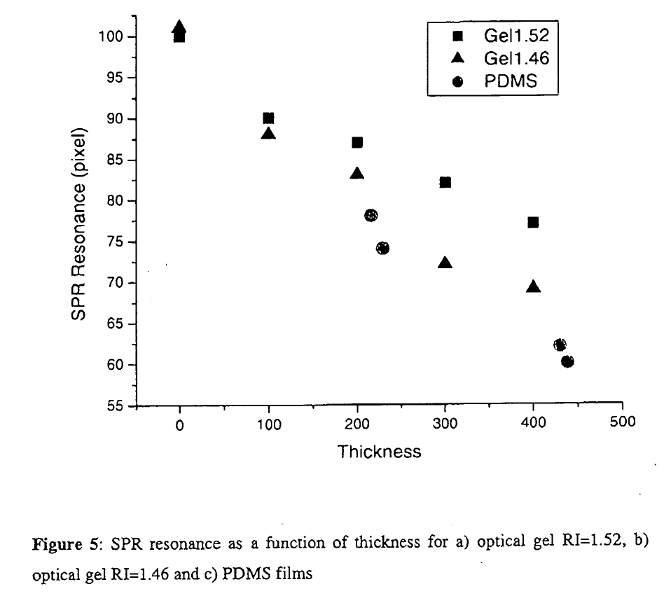

All sensors gave an SPR profile with a corresponding SPR angle. The SPR profile of the unmodified sensor and those obtained using the optical oil and gel are sensibly similar while it is noticed that the SPR angle for the PDMS coupled sensor and the free standing PDMS film coupled sensor are shifted to a lower pixel number. This shift to lower pixel position of the SPR resonance is attributed to the increased distance between the sensor surface and the gold reflective surface. FIG. 4 shows the SPR profiles of an optical gel with a refractive index of 1.52 as a function of increasing thickness. Clearly, the thicker refractive index material causes the SPR angle to shift to lower pixel values. FIG. 5 also illustrates that a similar shift in the SPR angle is observed when using an optical gel with a refractive index of 1.52, 1.46 and PDMS films of various thicknesses.

One of the important considerations when using a refractive index matching material is its likelihood to contaminate the optical surface. In SPR experiments, the material to be detected is deposited on the gold-coated surface with the risk that the refractive index matching materials may creep over the sides of the slide and onto the sensing surface. The refractive index matching oil was found to always creep over the sides onto the gold surface. The optical gel also managed to contaminate the gold surface, although not to the extent of the refractive index matching oil. Moreover, upon the removal of the gold-coated slide from the sensor surface, the backside of the slides is always covered with the refractive index oil or gel. The removal of these materials, without the contamination of the gold-coated surface, has proven to be extremely challenging, restricting dramatically any subsequent surface modifications of the sensing surface. Finally, the PDMS film that is cured in-situ between the gold-coated slide and the sensor surface also crept sometimes over the gold-coated slide, but upon curing, the PDMS can be cut away and peeled off the gold surface very easily, without leaving any residue, due to its very low surface tension characteristics. This feature provides for the reusability of the gold sensing surface after further chemical modification and subsequent SPR experiments. Moreover, the refractive indices of these silicone elastomers can be tailored over a large range by the appropriate choice of the starting components (Korenic (1995); Gu (1998)) making them a material of choice as all solid-state coupling layers. Additional advantages of these coupling materials include their low cost and ability to provide greater control in dynamic flow SPR experiments by making the glass slide stationary through the mechanical bonding of the two optical components. The use of the self-standing PDMS films as an all solid-state coupling layer, although very appealing, was found to be less satisfactory than its in-situ cured counterpart as has been already reported by Masadome et al. It was found that air bubbles were almost always trapped between the interlayers and were challenging to remove. The application of controlled pressures on the gold-coated substrate improved somehow the coupling but gives rise to a lot of variations in the recorded signal, while resulting also sometimes in the breaking of the thin gold-coated glass substrates.

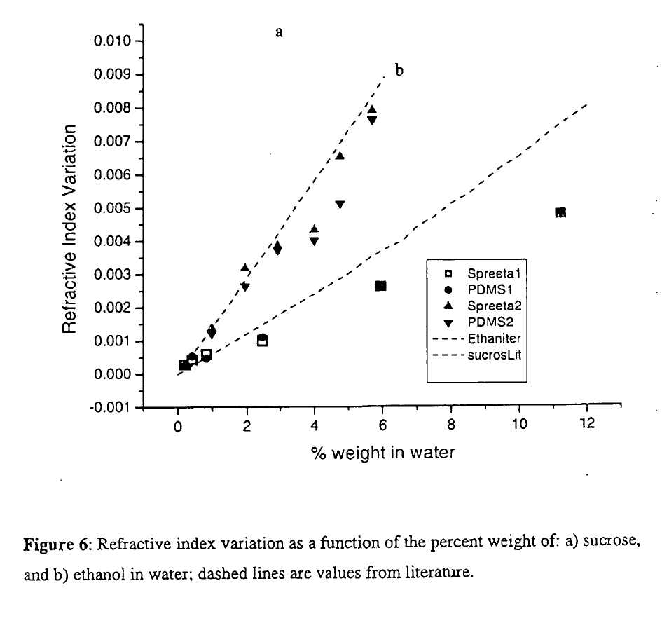

The response of the SPR sensor was investigated using previously reported methodologies to ensure that its sensitivity was not compromised. FIG. 6 illustrates a linear relationship between the refractive index change and the percent weight of: a) sucrose, and b) ethanol in water. The sensitivity of the sensors, which is given by the slope on these graphs, was larger for sucrose than for ethanol. In addition, the sensitivity of an unmodified and PDMS coupled sensor, were found to be identical. These results are in agreement with those reported in the literature (CRC Handbook of Chem. and Phys. 54^{th} ed. E-223 and D-200). Together, the detection limit and the sensitivity of this SPR sensor are adequate for determining the percent weight of the solutions when static experiments are performed. The analytical characteristics of the sensor do not appear to be compromised when PDMS is used to optically couple the glass slide to the sensor.

A curable silicone film is used to optically and mechanically couple two adjacent components in an SPR setup. Its optical characteristics are comparable to conventional refractive index matching oils and gels. This silicone elastomer has the advantage of being strippable, chemically inert, and cost-effective. The detection limit and sensitivity of the all solid-state PDMS coupled optical components were not compromised. Calibration curves for both sucrose and ethanol/water volume fractions indicated the proper response of the PDMS coupled SPR sensors.

We claim

1. A process of coupling two or more than two optical components, comprising the following steps;
a. providing a first optical component having at least one surface,
b. providing a removable and strippable silicone elastomer,
c. applying said silicone elastomer to at least a portion of said surface so as to provide a coupling layer thereon,
d. allowing said coupling layer to rest allowing the escape of trapped air,
e. providing a second optical component,
f. bonding said second optical component to said coupling layer to form a structure,
g. curing said coupling layer until said structure is set

2. The process of claim 1 comprising the additional step h of removing the coupling layer leaving the surface clean.

3. The process of claim 1 where the refractive index of said silicone elastomer is selected so as to minimize losses.

4. The process of claim 1 where steps a, b and e and f are carried out substantially simultaneously by injection of the silicone elastomer between the first and the second optical components.

5. The process of claim 2 where the silicone elastomer is in a viscous liquid.

6. The process of claim 2 where said silicone elastomer is provided as a solid sheet.

7. The process of claim 2 where the silicone elastomer is a Polydimethyl siloxane.

8. The process of claim 2 where a third optical component is provided and steps b to g are provided such that the structure comprises three bounded optical components.

9. The process of claim 1 where the curing of step g occurs by UV curing.

10. The process of claim 1 where the curing of step g occurs by moisture curing.

11. The process of claim 1 where the curing of step g occurs by heating the structure at a temperature ranging from room temperature up to the temperature the optical components can withstand without damage.

12. The process of claim 8 where the curing occurs at a temperature ranging from room temperature over days to about 100 degrees Celsius over a period of two hours.

13. The process of claim 8 where the heating occurs at a temperature of 60 degrees Celsius overnight.

14. A mixture for coupling optical components, comprising;
silicone elastomer and a curing agent.

15. The mixture of claim 10 where the silicone elastomer is a polydimethyl siloxane

16. The mixture of claim 10 where the mixture comprises of about ten parts of said silicone elastomer and one part of a curing agent.

17. The mixture of claim 10 where the mixture comprises about ten parts of said polydimethyl siloxane and one part of a curing agent.

18. A kit for coupling optical components comprising a silicone elastomer and a set of instructions.
